(19) United States
(12) Patent Application Publication
(10) Pub. No.: US 2023/0281310 A1
(43) Pub. Date: Sep. 7, 2023

(54) SYSTEMS AND METHODS OF UNCERTAINTY-AWARE SELF-SUPERVISED-LEARNING FOR MALWARE AND THREAT DETECTION

(71) Applicant: META PLATAFORMS, INC., Menlo Park, CA (US)

(72) Inventor: Li CHEN, Newark, CA (US)

(21) Appl. No.: 17/683,615

(22) Filed: Mar. 1, 2022

(51) Int. Cl. G06F 21/56; G06N 5/04

(52) U.S. Cl. CPC G06F 21/566; G06N 5/048

(57) ABSTRACT

A system may be configured to perform self-supervised learning for malware and threat intelligence such that unlabeled data is effectively used. Some embodiments may: obtain training data comprising executable portions of unlabeled information; learn, from the training data, latent representations of the unlabeled information; automatically determine labels from the training data based on the learned latent representations of the unlabeled information; predict, via contrastive learning trained using the labeled training data and deployed using the unlabeled training data, a deterministic distribution of points in a latent space that indicates whether the executable portion(s) belongs to classes or clusters; and estimate, via a machine-learning model, an uncertainty distribution of points around the executable portion(s) indicated as belonging to one of the classes or clusters. The uncertainty distribution may indicate a confidence that the respective determined label accurately describes the latent representation(s) of the one class or cluster.

### TECHNICAL FIELD

The present disclosure generally relates to systems and methods for conducting analyses and responsive annotations, e.g., when detecting malware or other threats relative to online platforms and networks.

### BACKGROUND

Malware or other malicious software is often inadvertently obtained (e.g., a PDF may be downloaded or received in a mail or message) and interacted with (e.g., at a website). The nefarious event-triggering of such software is known to cause obtainment of users' credentials, passwords, credit card information, etc., and to otherwise attack, access, and contaminate accounts.

Machine learning (ML) algorithms of any known malware analyzers, annotators, and/or detectors employ fully supervised learning using labels of a training dataset. Supervised learning is the category of machine learning algorithms that require annotated training data.

Commercial or other known ML-based systems focus on improving accuracy of predetermined malware labels, which are predetermined to satisfy a quality criterion, robustness of said ML systems being degraded when otherwise trained with noisy malware labels. However, obtaining reliable and accurate labels is expensive and time-consuming.

### SUMMARY

Systems and methods are disclosed for using any obtainable applications (apps) as a training dataset, requiring substantially no labels thereof. Accordingly, one or more aspects of the present disclosure relate to a method for detecting an app as either malicious or benign, for labeling used in downstream supervised training to then accurately predict labels.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on non-transitory, computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a system in which malware and/or threats are detected, in accordance with one or more embodiments.

FIG. 2 illustrates an example of this system, in accordance with one or more embodiments.

FIG. 3 illustrates an example of augmenting images for a computer vision task, in accordance with the conventional art.

FIG. 4 illustrates an example of a system in which input software is augmented, in accordance with one or more embodiments.

FIG. 5 illustrates an example of a system in which uncertainty is estimated, in accordance with one or more embodiments.

FIG. 6 illustrates a process for implementing self-supervised learning of malicious software, without initially having high quality labels, in accordance with one or more embodiments.

FIG. 7 illustrates another process for implementing self-supervised learning of malicious software, without initially having high quality labels, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

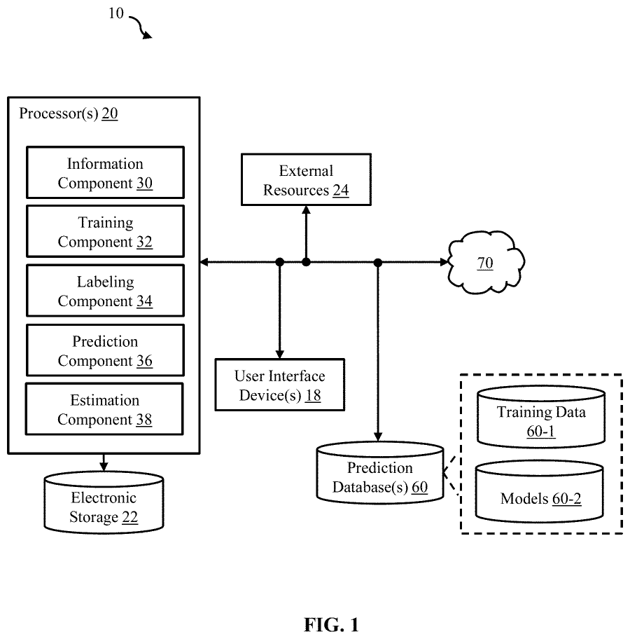

Presently disclosed are ways of building an effective and intelligent system that may navigate through many unknown and/or new applications (e.g., which do not have any labels) and detect them before attacks thereof are launched. For example, FIG. 1 illustrates system 10 configured without need of perfect labels to build a good detector or security analyzer.

In some embodiments, no annotation data may be included in training dataset 60-1. In other embodiments, a little annotated data may be included therein, to evaluate, as initial guidance, success of how the positive versus negative samples are selected.

In some embodiments, labeling, prediction, and estimation components 34, 36, and 38 may involve an uncertainty-aware self-supervised learning framework to detect or predict malware and threats (e.g., using almost no annotated malware in a training dataset). For example, a completely automated intelligent security robot may learn malware behaviors and identify the threats using contrastive learning. The self-supervised learning approach may further include uncertainty estimation, which learns a distribution and describes how confident the self-learning process is. System 10 thus not only produces a prediction with probability but also a confidence indication, level, or score about how accurate or certain the self-learning robot analyst thinks the piece of software is malware. As a result, the malware detector or robot may improve over time, e.g., without needing annotations from a third party.

In some embodiments, labeling component 34 may generate labels as training data, e.g., for training another machine-learning (ML) model.

The herein-disclosed approach improves by not requiring a sufficient number of high-quality malware for training a well-performing malware detector to predict unknown malware.

For example, a fully automated ML malware defender may be generated without relying on professional annotations. In this or another example, need for millions of labeled samples may be averted.

When applying self-supervised learning for malware detection, pretext task creation and/or data augmentation may be performed for inputted malware.

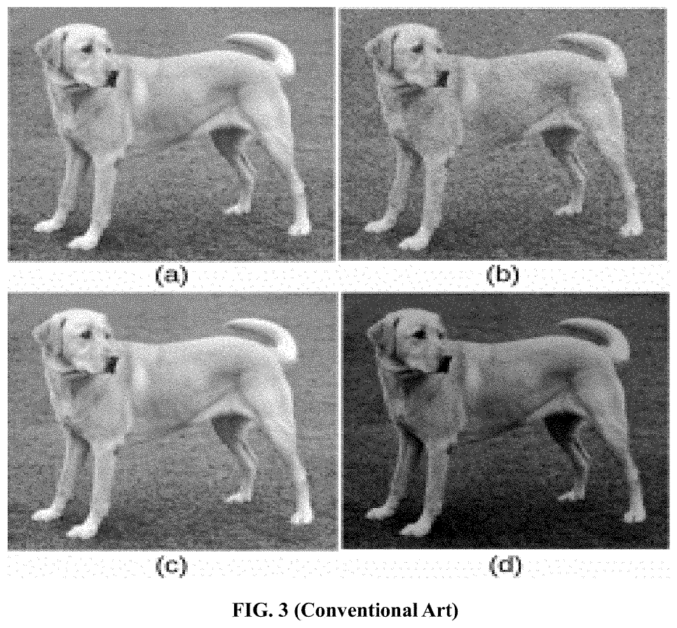

Herein-disclosed, self-supervised learning may improve upon ways of performing text analysis and computer vision. Computer vision (CV) comprises such transformations of pixels in images as are depicted in the example of FIG. 3, including cropping, rotation, and color change. For example, FIG. 3 shows exemplary performance of different coloring to achieve data augmentation.

FIG. 3 depicts data augmentation of an image on an image to create many transformed images. Contrastive learning may then be performed in addition to obtain better results.

Some disclosed embodiments employ self-supervised learning and may also incorporate deep learning uncertainty as a protocol to build a malware and threat detection system. In some implementations of a security analyzer, the need for any human (e.g., from security experts or crowdsourcing) annotations or labeling may be obviated. For example, self-supervised learning may be used, and then fuzzing may be utilized as one type of analysis to bridge the gap between self-supervised learning in computer vision and self-supervised learning in malware and threat detection.

Malware 50 may comprise binary file(s), e.g., represented between 0 to 255 as a pixel value, upon which a transformation may occur without needing to understand syntax for performing code-rewriting and while preserving operation of malicious (e.g., malware) behavior. For example, labeling component 34 may perform fuzzing to augment app 50 via pretext task creation. Fuzzing may be a software testing technique that is used to explore the application's vulnerabilities. It may create a variety of inputs and may send to the applications to observe the outputs. For example, the inputs that triggered malfunctioned behaviors or diverse behaviors of the applications may be noted. Fuzzing may thus be a way to close the gap between malware analysis and self-supervision.

As used herein, malware binary may comprise an original application (app) in binary form, which can be represented in bits and transformed into pixel values (e.g., between 0 and 255). In some embodiments, a sample of app data or software 50 (e.g., malware) may comprise executable data, such as binary file(s) of original malware or another original app.

In some embodiments, pretext tasking may be addressed when performing malware detection self-learning. For example, labeling component 34 may implement fuzzing and dynamic analyses, to generate diversified malware samples from the same original malware file. In these or other embodiments, uncertainty estimation may be performed in a self-supervised framework for malware detection. For example, another layer of accurate prediction may be provided via a confidence score on whether the app is indeed a piece of malware.

In some embodiments, model 60-2 may predict that executable portion (e.g., malware) 50 is in a space with an accuracy (e.g., with a confidence, probability, or score). The accuracy may be used for determining whether app 50 satisfies a criterion (i.e., whether it is benign or malicious). And the confidence score may make system 10 more robust.

In some embodiments, labeling component 34 may perform augmentation, fuzzing, or a pretext task, e.g., to learn more latent representations for then separating out samples (e.g., of malware) 50 that are benign from those that are malicious.

In some embodiments, labeling component 34 may perform dynamic analysis by having different ways of inputting an interaction into app 50. For example, this component may capture all different behaviors over time, with some parts exhibiting the behavior earlier versus some parts exhibiting the behavior later, depending on how the user triggers it. As such, the dynamic analysis may cause obtainment of diversified samples.

In some implementations, app 50 may comprise binary file(s) for implementing or spawning up a web page. For example, a displayed UI (e.g., via UI devices 18) may be interacted at by a user (e.g., clicking in certain regions of the web page) as input of that app. In this or another example, by a user clicking on a region of the app, some malicious behavior (e.g., ransomware, phishing, accessing important documents, password stealing, etc.) may be triggered. For example, labeling component 34 may simulate different inputs (e.g., depending on where the user clicks on the webpage, by scrolling down for some period of time, etc.) at malware 50 such that the behavior (e.g., redirecting to a different website upon interacting with a logo) may be activated. Prediction component 36 may then, e.g., observe the resulting output, which may also be captured as a binary representation for subsequently translating (e.g., into a computer vision image value).

In some embodiments, upon performing a fuzzing procedure, the sandboxing of different app behaviors improves via increased security (i.e., by not activating in a real, live network). A variety of inputs to the app may respectively cause different types of outputs at app 50.

In some embodiments, the augmentation may result in many (e.g., five or six) inputs, which may result in differently representative outcomes or behaviors. For example, the threat of app 50 may be triggered via a short sequence or a longer sequence. Accordingly, labeling component 34 may use the fuzz inputs as a way to trigger as many ways as possible to see the outcome of the malware. For example, app 50 may not just be directing a user to one webpage but rather multiple different types of malicious webpages (e.g., depending on where the user clicks, how long the user waits at the website, or other observable behavior).

In implementations of app 50 that are more simplistic, fuzzing performed for different inputs may not result in substantially variant outputs. However, more dynamic apps 50 (e.g., having some delay in showing the attack, requiring scrolling for a few seconds, or requiring reaching an end of a PDF document) may be represented as the original software to capture the variety of results of this software.

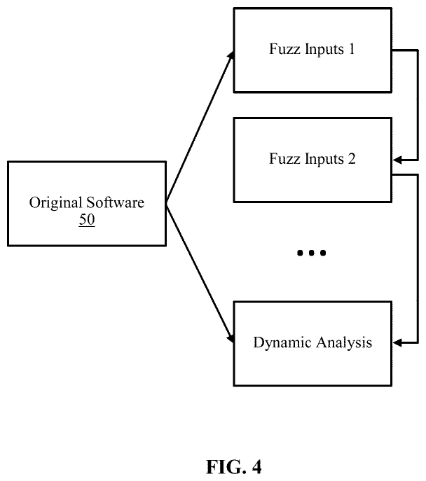

In the example of FIG. 4 is depicted contrastive learning, which may take pairs. For example, fuzz inputs 1 and 2 may be a pair, with only three being plotted such that two (combinations) are chosen and fed into the contrastive learning. The loss function may describe how similar these inputs are. For example, if they are from different software portions 50, then the outputs from fuzzing inputs 1 of a first software and fuzzing inputs 2 of another software may result in very dissimilar plots, one being benign and the other malicious. That is, the contrastive learning may push them apart because they are dissimilar.

In some embodiments, labeling, prediction, and estimation components 34, 36, and 38 may perform contrastive learning as a machine learning technique to learn general features of a dataset without labels by teaching the model which data points are similar or different. With contrastive learning, model performance may be improved even when only a fraction of the dataset is labeled. And binary file(s) 50 (e.g., which may be malware) may be fed into deep learning model 60-2 to create vector representations for each file or file portion. Then, the model may be trained to output similar representations for similar inputs 50 (e.g., malware). And a component of processors 20 may maximize the similarity of vector representations by minimizing a contrastive loss function.

In alternative embodiments, a generative adversarial network (GAN) may be employed, which may need some sort of labels (e.g., when implementing conditional GAN).

In some embodiments, the number of layers of network 60-2 may be proportional to the amount of data, e.g., with billions of data pieces resulting in a very deep network.

In some embodiments, labeling component 34 may perform fuzzing to represent each software via a few augmented samples. In some embodiments, labeling component 34 may perform fuzzing as a pretext task, when performing the self-supervised learning, resulting in diversified malware inputs that are fed into app 50 to then observe corresponding outputs of the app. For example, the diversified malware samples generated by labeling component 34 may represent an original malware software into multiple pieces via fuzzing and dynamic analysis. Via contrastive learning, the malware that is represented via different fuzzing inputs may have maximal similarity; and the malware and the benign ware may have maximum dissimilarity. In these or other embodiments, labeling component 34 learns the underlying representation of the malware and produces pseudo-labels. Downstream tasking may comprise malware classification or clustering.

In some embodiments, processors 20 may implement self-supervised learning based on pseudo-labels (e.g., to initialize weights of an ANN). For example, training data may be divided into positive (i.e., matching) examples and negative (i.e., missing) examples. Contrastive self-supervised learning is contemplated, e.g., by using both positive and negative examples and where a loss function minimizes a distance between positive samples while maximizing a distance between negative samples. Non-contrastive self-supervised learning is also contemplated, e.g., by using only positive examples.

In some embodiments, estimation component 38 may provide uncertainty estimation in self-supervised learning and downstream tasking of malware defense.

In some embodiments, models 60-2 may be implemented without human interaction. And this model may be added as a flexible component to any system, including a human feedback loop to co-enhance efficiency of the performance. For example, one or more of labeling, prediction, and estimation components 34, 36, and 38 may be a flexible component added to an existing system that has a human in the loop, e.g., to check or determine the accuracy of the human's annotations or labels. As such, one or more components of processors 20 may enhance a self-supervised learning system as an evaluation tool to reinforce the contrastive learning.

In some embodiments, labeling component 34 may implement fuzzing and dynamic analysis to build a pretext task for augmentation, when applying self-supervised learning to malware detection. For example, labeling component 34 may implement such malware analysis as fuzzing, which may comprise providing app 50 as many diverse inputs as possible and/or observing outputs thereof that can be used to identify where app 50 fails (e.g., begins executing nefarious behavior, such as by launching a security threat). In this or another example, labeling component 34 may implement dynamic analysis, e.g., via a sandbox to test-run the malware with respect to demonstrating runtime behavior.

The herein-disclosed fuzzing and sandboxing as augmentation may form part of pretext task creation. For example, prediction component 36 may utilize fuzzing and dynamic analysis to augment the original malware piece such that each portion of software can be represented by a few augmented samples. Then, during the self-learning process, prediction component 36 may optimize the loss on the pairwise samples, so that the same app from different fuzzing inputs or from dynamic analysis will be represented closely in the learned representation space. In other words, the dynamic analysis may comprise using a sandbox or a simulated environment to run the malware such that malicious behavior is operable to be launched at runtime.

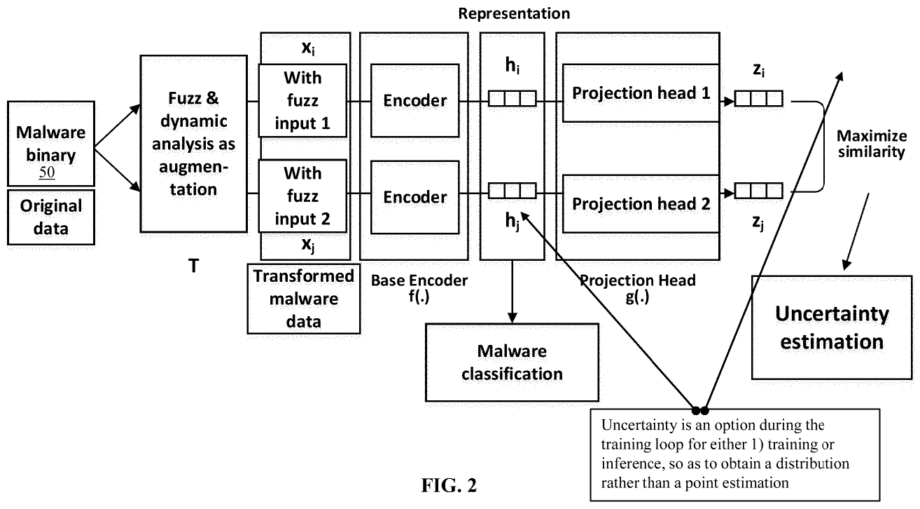

In some embodiments, the fuzzing may comprise inputting different inputs, e.g., including different types of input into app 50, resulting in different types of results from app 50 (label as malware 50 from FIG. 2). As an example of such pretext task, both static analysis or dynamic analyses may be performed such that each app becomes represented by many other augmented apps.

For example, app 50 may be installed at a sandbox, the app may be allowed to run, and then different variance of that running app may be obtained. In app 50 reacting to different types of input, the app may generate different types of output (e.g., dynamic binary behavior, each resulting in different behavior).

In some embodiments, when the augmentation gets more complex, malware and threat intelligence model 60-2 may improve. For example, if a diverse number of inputs are chosen to fuzz the program, the model performance may implement improvement.

In some embodiments, inputted training dataset 60-1 may include many contrastive negative samples. And then labeling component 34 may place the negative and positive labels into separate spaces. For example, the contrastive learning may separate samples upon establishing a loss function and during the learning. Contrastive loss may try to minimize the difference when two data points are similar. The general formula for Contrastive Loss may be

L(W,(Y,X₁,X₂)ⁱ)=(1−Y)L_{S}(D_{w}ⁱ)+YL_{D}(D_{w}ⁱ)

where Y (e.g., 1 or 0) indicates whether the two points X1 and X2 are similar or dissimilar. The D_w may be defined as follows: D_{w}(X₁, X₂)=∥ƒ_{w}(X₁)−ƒ_{w}(X₂)∥₂ and f is the function describing the neural networks.

In some embodiments, labeling component 34 may minimize and maximize dissimilar and similar inputs, such that a training mechanism is implemented and the loss function is defined for subsequent use.

As depicted in the example of FIG. 2, models 60-2 may comprise a first model dedicated to pre-text task creation, a second model dedicated to encoding, a third model implemented as a projection head, and/or a fourth model computing similarity with an uncertainty estimation. FIG. 2 further depicts an example of self-supervised learning, e.g., which may include pre-training. An example of such pre-training may include all functional blocks in FIG. 2 from the pretext task creation to the projection head.

In some embodiments. the encoder of FIG. 2 may comprise different types of backbones. For example, the encoder may implement different types of ResNet with different depths. As the amount of data increases, a deeper ResNet may be used, in some implementations. Other contemplated backbones include deeper/denser ones, such as ResNeXt, AmoebaNet, AlexNet, VGGNet, Inception, etc., or a more lightweight backbone, such as MobileNet, ShuffleNet, SqueezeNet, Xception, MobileNetV2, etc.

In some embodiments, one or more projection heads depicted in FIG. 2 may be included in the architecture of model 60-2. For example, prediction component 36 may select a different type of projection head and measure ensuing performance. In this or another example, prediction component 36 may use normalized temperature-scaled cross entropy loss as a contrastive loss. The normalized temperature scaled cross entropy loss may be a loss function. The cosine similarity between data points z_i and z_j may be denoted. The function 1_{[k≠i]}∈{0,1} is an indicator function when k=i, it is 1 and when k does not equal to i, it is 0. This loss computes across all positive pairs in a mini-batch.

$${ℓ}_{i , j} = - log \frac{exp ( sim ( {z}_{i} , {z}_{j} ) / τ )}{{\sum }_{k = 1}^{2 N} {[ k \neq i ]}_{} exp ( sim ( {z}_{i} , {z}_{k} ) / τ )}$$

The projection head can be multi-layer perceptron (MLP), fixed MLP, deeper MLP.

The projection head may comprise a structured neural network (i.e., for the contrastive learning) that performs a transformation function on the embeddings. Given a static binary, it may be mapped directly to an array of integers between 0 and 255. Hence each binary may be converted into a one-dimensional array v ∈ [0, 255]. Then the array v may be normalized to [0, 1] by dividing by 255. The normalized array v may then be reshaped into a two dimensional array v 0. The binary may be resized where the width is determined with respect to the file size. The height of the file may be the total length of the one-dimensional array divided by the width. The height may be round up and zeros may be pad if the width is not divisible by the file size. Chen, L. (2018). “Deep Transfer Learning for Static Malware Classification.” arXiv preprint arXiv: 1812.07606.

In some embodiments, the projection head of FIG. 2 may comprise a set of dense layers, e.g., to transform the data into another space.

In some embodiments, uncertainty awareness may be additionally employed to add a confidence estimation or score, e.g., as to of how well model 60-2 is deriving annotations during the self-supervised learning procedure. For example, false predictions of annotations may be avoided using uncertainty estimation, which is an estimation around the distribution of what the self-supervised learner generates. In this or another example, a confidence score may be provided by estimation component 38 to indicate an extent as to which model 60-2 predicts that this is indeed the expected latent representation learning from the self-supervised learning protocol.

Uncertainty estimation in system 10 may indicate how confident the self-learning and downstream tasks (e.g., malware classification or clustering) are, providing another dimension of efficacy guarantee. In such downstream tasking, the embeddings or latent representations may be learned from self-learning, resulting in a complete end-to-end AI system.

In some embodiments, a component of processors 20 may implement self-supervised learning, which may be a type or subset of unsupervised learning and may not require any labelled data. This self-supervision may result in the pseudo labels and may teach a classifier to learn representations (e.g., without needing good labels to train a good classifier). The representations can be used in downstream tasking. Such downstream tasking may, e.g., comprise malware classification, as depicted in FIG. 2, clustering, and/or another suitable function.

In some embodiments, a component of processors 20 may perform contrastive learning based on two inputs being similar, e.g., with the representation function f being used to map them into close space; and if two inputs are dissimilar, the representation function f may map them further away. Function f may be a function to represent a neural network. Examples of the loss functions include:

cross-entropy loss:

$$- {\sum }_{c = 1}^{M} {y}_{o , c} log ( {p}_{o , c} )$$

triplet loss:

$${ℒ}_{triplet} ( x , {x}^{+} , {x}^{-} ) = {\sum }_{x ∈ 𝒳} max ( 0 , {‖ f ( x ) - f ( {x}^{+} ) ‖}_{2}^{2} - {‖ f ( x ) - f ( {x}^{-} ) ‖}_{2}^{2} + ϵ )$$

contrastive loss (see above).

In some embodiments, a component of processors 20 may perform contrastive learning, the similarity being based on how the loss function is set up (and how the training is set up). For example, the loss function may be set up in terms of what it wants to minimize, with the estimated latent representation being pushed towards one group or class if it is malware. Accordingly, once a bridge is built between the augmentation of computer vision and the pretext task of malware detection, the contrastive learning may then be performed.

In some embodiments, a component of processors 20 may perform contrastive learning, e.g., by pulling together augmented samples expected to have a similar representation and by pushing apart random or unrelated samples expected to have different representations.

In some embodiments, labeling and prediction components 34 and 36 may perform self-supervision to learn effective representations of data from an unlabeled pool of data. Then, estimation component 38 may fine-tune the representation with very few labels for a downstream supervised learning task. For example, the self-supervised learning may learn the latent representation without any labels, but the fine-tuning of the representation may be performed with very few labels for a downstream task.

In some embodiments, prediction component 36 may automatically triage sample inputs 50 into clusters, e.g., with a first cluster being all benign and another cluster being all malicious, but this component may not know which cluster is malicious and which one is benign. Accordingly, a downstream task may be used to verify the type of each cluster.

In some embodiments, labeling and prediction components 34 and 36 may implement self-supervised learning, e.g., of a latent representation of malware 50 and/or another portion of obtained software. For example, latent representations may comprise malware placed in some multi-dimensional space and/or benign-ware placed in another multi-dimensional space, the placements having a criterion-satisfying amount of separation. Each dimension in the latent space may correspond to a different latent representation or feature, i.e., to represent app 50.

In some embodiments, rather than a single, multi-dimensional, and deterministic point in latent space, which is not very trustworthy, estimation component 38 may represent app 50 more robustly via a machine-learned estimation. For example, via uncertainty estimation, more than one point may be predicted, e.g., with estimation component 38 describing a distribution around the point. In this or another example, the uncertainty estimation may comprise a first distribution around the X coordinates, a second distribution around the Y coordinates, and/or a third distribution around the Z coordinates, for a 3D space. As such, the distribution may indicate how likely app 50 belongs to a certain space.

In some embodiments, estimation component 38 may utilize the uncertainty estimations (e.g., latent representation predicted by prediction component 36) to determine a confidence that prediction component 36 is about the location of an estimated set of points (e.g., plotted in the latent space). For example, the downstream self-supervised learning tasking may include prediction, using the determined confidence (e.g., score) as an extra layer of information, whether piece of app 50 is malware.

In some embodiments, the uncertainty estimation may be performed via a self-supervised learning framework.

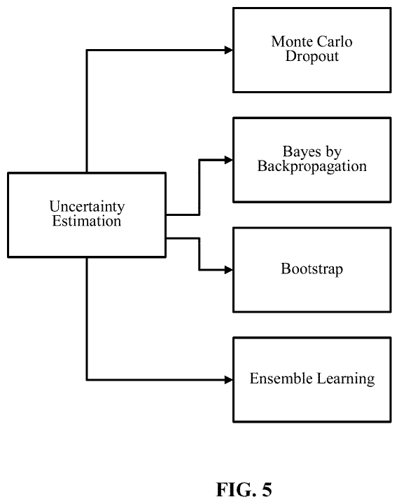

FIG. 5 depicts one or more techniques configured to add uncertainty estimation on top of self-supervised learning. For example, one or more of the techniques may be selected based on a particular app, scenario, and/or need.

In some embodiments, estimation component 38 may implement Monte Carlo dropout with an approach substantially the same as the Monte Carlo method. For example, models 60-2 may include a neural network that has dropout layers. Such dropout may include switching-off some neurons at each training step, e.g., to prevent overfitting. And a dropout rate may be determined based on the network type, layer size, and the degree to which the network overfits the training data.

Herein-contemplated is implementation of an algorithm based on Monte Carlo, e.g., using repeated random sampling to obtain a distribution of some numerical quantity. For example, regular dropout may be interpreted as a Bayesian approximation of a Gaussian model. Many different networks (with different neurons dropped out) may be treated as Monte Carlo samples from a space of available models. Dropout may be applied at test time. As such, dropout may be performed at both training and testing time.

Then, instead of one prediction, each model may make one prediction for averaging them or analyzing their distributions. In some embodiments, Monte Carlo dropout may provide much more information about the prediction uncertainty. Regression and classification tasks are contemplated as well.

In some embodiments, estimation component 38 may employ Bayesian statistics to derive conclusions based on both data and prior knowledge about the underlying phenomenon. For example, parameters may be distributions instead of fixed weights. And uncertainty may be estimated over the weights.

In some embodiments, deep ensembling may be used to learn the weights' distribution, e.g., where a large number of models or re-multiple copies of a model are trained on respective datasets and their resulting predictions collectively build a predictive distribution. For an uncertainty interval, estimation component 38 may calculate the variance of predictions to provide the ensemble's uncertainty.

In some embodiments, estimation component 38 may implement Bayes by back-propagation, e.g., to train a model, obtaining a distribution around the parameters. For example, Bayes by backpropagation may be implemented by initially assuming a distribution of parameters. Then, when performing the back propagation, estimation component 38 may estimate a distribution on the parameters, e.g., assuming a Gaussian distribution on the parameter. In this or another example, estimation component 38 may estimate a mean and a standard distribution. Then, this component may draw from that distribution to obtain the parameter, e.g., when performing the back propagation.

Incorporating a prior belief in investigating a posterior state may be a characteristic of herein-implemented, Bayesian reasoning. For example, model 60-2 may comprise a Bayesian network or decision network, including a probabilistic graphical model that represents a set of variables and their conditional dependencies via a directed acyclic graph (DAG). In this or another example, the model may be used to predict likelihood that any one of several possible known causes was a contributing factor of an event.

In some embodiments, estimation component 38 may implement Bootstrap sampling, e.g., to provide a distribution of parameters. For example, such bootstrapping may include a test or metric, using random sampling with replacement (e.g., mimicking the sampling process) and resampling. This bootstrapping may, e.g., assign measures of accuracy (bias, variance, confidence intervals, prediction error, etc.) to sample estimates, to estimate the sampling distribution of a statistic. And this bootstrapping may estimate the properties of an estimator (such as its variance) by measuring those properties when sampling from an approximating distribution.

In some embodiments, estimation component 38 may implement ensemble learning, e.g., to provide a distribution of parameters. For example, such learning may be implemented via multiple networks, resulting in the distribution.

As such, none of the techniques depicted in FIG. 5 may generate a deterministic point but rather a distribution of points.

In some embodiments, uncertainty estimation may be incorporated in representation learning. Without labels, an assurance of effective and accurate representation learning may be implemented by one or more components of processors 20 to estimate the epistemic and aleatoric uncertainty of the self-learning model. As a result, each learned representation may have a confidence score to describe how well the estimation is. For example, if the confidence score is low (or uncertainty is high), then the learned representation may not be trusted and instead fed back into the learning loop. If the confidence score is high (or uncertainty is low), then this representation may be trusted more. In some implementations, it may be desirable for similar samples to be determined to be as close as possible to sample app 50.

In some embodiments, prediction component 36 may pass sample 50 through the algorithm of model 60-2, and then if the confidence score is low this component may pass it through again, looping back until a greater amount of trust or confidence is obtained of the representation that it is malicious or benign.

In some embodiments, the uncertainty estimation functional block of FIG. 2 may be achieved by using a variety of uncertainty estimation techniques, including those depicted in FIG. 5.

In some embodiments, estimation component 38 may perform epistemic uncertainty, e.g., to describe what model 60-2 does not know because its training data was not appropriate or when there are too few samples for training. Epistemic uncertainty may be due to limited data and knowledge. For example, given enough training samples, epistemic uncertainty may decrease.

In some embodiments, estimation component 38 may perform aleatoric uncertainty, e.g., which may be the uncertainty arising from natural stochasticity of observations. Aleatoric uncertainty may not be reduced even when more data is provided.

In some embodiments, the epistemic uncertainty of the model parameters may be estimated, or the aleatoric uncertainty of the data may be estimated. Given enough training samples, epistemic uncertainty decreases. Epistemic uncertainty may arise in areas where there are fewer samples for training. In some embodiments, estimation component 38 may sum both epistemic and aleatoric uncertainty, e.g., to provide total uncertainty.

In some embodiments, labeling and prediction components 34 and 36 may perform self-supervised learning to learn a latent representation or embedding of each of these sample inputs or apps 50. And estimation component 38 may generate a distribution to describe each of those embeddings. Typically, a single embedding may be considered deterministic, but in the herein-disclosed approach uncertainty implies randomness. For example, extra dimensions may be added to that embedding to describe a distribution of embeddings. Conventionally, an embedding may be represented three-dimensionally as a single point (e.g., 0, 0, 0 for respective X, Y, and Z axes), there being no uncertainty. With uncertainty estimation implemented via estimation component 38 a learned distribution may comprise an average or a Gaussian bell curve distribution (e.g., with a mean being zero, but spread out having a high standard deviation or with a very sharp distribution).

Then, estimation component 38 may use that distribution to estimate how confident it is of the latent representation. In some embodiments, one or more of the dimensions may have its own distribution. But not each dimension must have a distribution, only some of which having such. The distribution may indicate how far away a point in the latent space may move, with an uncertainty and with a confidence score. The latent space may be a learned representation space.

In some embodiments, estimation component 38 may generate a confidence score, which may refer to the score derived from the distribution (i.e., which may be generated per each prediction). That is, prediction component 36 may first predict belongingness to one of a plurality of classes, with each class having a different probability. As such, the predicted probability for all classes may sum up to one, e.g., with one class being identified as having a highest probability of 0.7, this one class being selected.

Then, estimation component 38 may incorporate uncertainty estimation by estimating a distribution that is only centered against the one selected class. For example, the distribution may be spread out, the variance being very high, which may indicate that the network or predictor is not very certain that the embedding does indeed belong to that one class.

Accordingly, the prediction probability may be deterministic, predicted via a deterministic neural network, and the confidence score may be computed from a distribution, which may include computation of the entropy and computation of the variance per class (i.e., from uncertainty estimation). For example, the predictive distribution may indicate a high probability (e.g., 70%, with a spike around the one class), but the uncertainty estimation around the one class may actually be flat, indicating a low amount of confidence that this embedding belongs to that one class. As such, the probability distribution may be across all the classes, but the confidence score distribution may be centered around a single class.

Artificial neural networks (ANNs) are models used in machine learning that may have artificial neurons (nodes) forming a network through adjustable synaptic interconnections (weights), e.g., at least throughout training. An ANN may be configured to determine a classification (e.g., type of object) based on input image(s) or other sensed information. Such artificial networks may be used for predictive modeling. The prediction models may be and/or include one or more neural networks (e.g., deep neural networks, artificial neural networks, or other neural networks), other machine learning models, or other prediction models.

Each neural unit of a neural network may be connected with many other neural units of the neural network. Such connections may be enforcing or inhibitory, in their effect on the activation state of connected neural units. In some embodiments, neural networks may include multiple layers (e.g., where a signal path traverses from input layers to output layers). In some embodiments, back propagation techniques may be utilized to train the neural networks, where forward stimulation is used to reset weights on the front neural units.

Disclosed implementations of artificial neural networks may apply a weight and transform the input data by applying a function, this transformation being a neural layer. The function may be linear or, more preferably, a nonlinear activation function, such as a logistic sigmoid, Tanh, or rectified linear activation function (ReLU) function. Intermediate outputs of one layer may be used as the input into a next layer. The neural network through repeated transformations learns multiple layers that may be combined into a final layer that makes predictions. This learning (i.e., training) may be performed by varying weights or parameters to minimize the difference between the predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

An ANN is characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. And the hyperparameters are set before learning, and model parameters can be set through learning to specify the architecture of the ANN.

Learning rate and accuracy of an ANN rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters.

The hyperparameters may include initial values of weights and biases between nodes, mini-batch size, iteration number, learning rate, and so forth. Furthermore, the model parameters may include a weight between nodes, a bias between nodes, and so forth.

In general, the ANN is first trained by experimentally setting hyperparameters to various values, and based on the results of training, the hyperparameters can be set to optimal values that provide a stable learning rate and accuracy.

Some embodiments of models 60-2 may comprise a convolutional neural network (CNN). A CNN may comprise an input and an output layer, as well as multiple hidden layers. The hidden layers of a CNN typically comprise a series of convolutional layers that convolve with a multiplication or other dot product. The activation function is commonly a ReLU layer, and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

In some embodiments, the learning of models 60-2 may be of reinforcement, supervised, and/or unsupervised type. For example, there may be a model for certain predictions that is learned with one of these types while another model for other predictions may be learned with another of these types.

Supervised learning is the machine learning task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which can be used for mapping new examples. And the algorithm may correctly determine the class labels for unseen instances.

Unsupervised learning is a type of machine learning that looks for previously undetected patterns in a dataset with no pre-existing labels. In contrast to supervised learning that usually makes use of human-labeled data, unsupervised learning does not via principal component (e.g., to preprocess and reduce the dimensionality of high-dimensional datasets while preserving the original structure and relationships inherent to the original dataset) and cluster analysis (e.g., which identifies commonalities in the data and reacts based on the presence or absence of such commonalities in each new piece of data). Semi-supervised learning is also contemplated, which makes use of supervised and unsupervised techniques.

Once trained, prediction model 60-2 of FIG. 1 may operate at a rate of 100 samples/minute, more than 1,000 samples per minute, or more than 10,000 samples per minute. Training component 32 of FIG. 1 may thus prepare one or more prediction models to generate predictions. Models 60-2 may analyze made predictions against a reference set of data called the validation set. In some use cases, the reference outputs resulting from the assessment of made predictions against a validation set may be provided as an input to the prediction models, which the prediction model may utilize to determine whether its predictions are accurate, to determine the level of accuracy or completeness with respect to the validation set data, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model.

In some embodiments, training component 32 may implement an algorithm for building and training one or more deep neural networks. In some embodiments, training component 32 may train a deep learning model on training data 60-1 providing even more accuracy, after successful tests with these or other algorithms are performed and after the model is provided a large enough dataset.

A model implementing a neural network may be trained using training data obtained by training component 32 from training data 60-1 storage/database. The training data may include many attributes of an app. For example, this training data obtained from prediction database 60 of FIG. 1 may comprise hundreds, thousands, or even many millions of pieces of software. The dataset may be split between training, validation, and test sets in any suitable fashion. For example, some embodiments may use about 60% or 80% of the images for training or validation, and the other about 40% or 20% respectively may be used for validation or testing. In another example, training component 32 may randomly split the labelled images, the exact ratio of training versus test data varying throughout. When a satisfactory model is found, training component 32 may train it on 95% of the training data and validate it further on the remaining 5%.

The validation set may be a subset of the training data, which is kept hidden from the model to test accuracy of the model. The test set may be a dataset, which is new to the model to test accuracy of the model. The training dataset used to train prediction models 60-2 may leverage, via training component 32, an SQL server and a Pivotal Greenplum database for data storage and extraction purposes.

In some embodiments, training component 32 may be configured to obtain training data from any suitable source, via electronic storage 22, external resources 24 (e.g., which may include sensors), network 70, and/or UI device(s) 18. The training data may comprise captured images, smells, light/colors, shape sizes, noises or other sounds, and/or other discrete instances of sensed information.

In some embodiments, training component 32 may enable one or more prediction models to be trained. The training of the neural networks may be performed via several iterations. For each training iteration, a classification prediction (e.g., output of a layer) of the neural network(s) may be determined and compared to the corresponding, known classification. For example, sensed data known to capture a closed environment comprising dynamic and/or static objects may be input, during training or validation, into the neural network to determine whether the prediction model may properly predict a path for the user to reach or avoid said objects. As such, the neural network is configured to receive at least a portion of the training data as an input feature space. Once trained, the model(s) may be stored in database/storage 60-2 of prediction database 60, as shown in FIG. 1, and then used to classify samples of images based on visible attributes.

Electronic storage 22 of FIG. 1 comprises electronic storage media that electronically stores information. The electronic storage media of electronic storage 22 may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a user interface (UI) device 18, processor 20, etc.). In some embodiments, electronic storage 22 may be located in a server together with processor 20, in a server that is part of external resources 24, in UI devices 18, and/or in other locations. Electronic storage 22 may comprise a memory controller and one or more of optically readable storage media (e.g., optical disks, etc.), magnetically readable storage media (e.g., magnetic tape, magnetic hard drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via UI devices 18 and/or other external computing systems, information received from external resources 24, and/or other information that enables system 10 to function as described herein.

External resources 24 may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 24 may be provided by other components or resources included in system 10. Processor 20, external resources 24, UI device 18, electronic storage 22, a network, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

UI device(s) 18 of system 10 may be configured to provide an interface between one or more users and system 10. UI devices 18 are configured to provide information to and/or receive information from the one or more users. UI devices 18 include a UI and/or other components. The UI may be and/or include a graphical UI configured to present views and/or fields configured to receive entry and/or selection with respect to particular functionality of system 10, and/or provide and/or receive other information. In some embodiments, the UI of UI devices 18 may include a plurality of separate interfaces associated with processors 20 and/or other components of system 10. Examples of interface devices suitable for inclusion in UI device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 18 include a removable storage interface. In this example, information may be loaded into UI devices 18 from removable storage (e.g., a smart card, a flash drive, a removable disk) that enables users to customize the implementation of UI devices 18.

In some embodiments, UI devices 18 are configured to provide a UI, processing capabilities, databases, and/or electronic storage to system 10. As such, UI devices 18 may include processors 20, electronic storage 22, external resources 24, and/or other components of system 10. In some embodiments, UI devices 18 are connected to a network (e.g., the Internet). In some embodiments, UI devices 18 do not include processor 20, electronic storage 22, external resources 24, and/or other components of system 10, but instead communicate with these components via dedicated lines, a bus, a switch, network, or other communication means. The communication may be wireless or wired. In some embodiments, UI devices 18 are laptops, desktop computers, smartphones, tablet computers, and/or other UI devices.

Data and content may be exchanged between the various components of the system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol (IP) defines addressing methods and structures for datagram encapsulation. Of course other protocols also may be used. Examples of an Internet protocol include Internet Protocol version 4 (IPv4) and Internet Protocol version 6 (IPv6).

In some embodiments, processor(s) 20 may form part (e.g., in a same or separate housing) of a user device, a consumer electronics device, a mobile phone, a smartphone, a personal data assistant, a digital tablet/pad computer, a wearable device (e.g., watch), augmented reality (AR) goggles, virtual reality (VR) goggles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 20 is configured to provide information processing capabilities in system 10. Processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., one or more servers, UI devices 18, devices that are part of external resources 24, electronic storage 22, and/or other devices).

As shown in FIG. 1, processor 20 is configured via machine-readable instructions to execute one or more computer program components. The computer program components may comprise one or more of information component 30, training component 32, labeling component 34, prediction component 36, estimation component 38, and/or other components. Processor 20 may be configured to execute components 30, 32, 34, 36, and/or 38 by: software; hardware; firmware; some combination of software, hardware, and/or firmware; and/or other mechanisms for configuring processing capabilities on processor 20.

It should be appreciated that although components 30, 32, 34, 36, and 38 are illustrated in FIG. 1 as being co-located within a single processing unit, in embodiments in which processor 20 comprises multiple processing units, one or more of components 30, 32, 34, 36, and/or 38 may be located remotely from the other components. For example, in some embodiments, each of processor components 30, 32, 34, 36, and 38 may comprise a separate and distinct set of processors. The description of the functionality provided by the different components 30, 32, 34, 36, and/or 38 described below is for illustrative purposes, and is not intended to be limiting, as any of components 30, 32, 34, 36, and/or 38 may provide more or less functionality than is described. For example, one or more of components 30, 32, 34, 36, and/or 38 may be eliminated, and some or all of its functionality may be provided by other components 30, 32, 34, 36, and/or 38. As another example, processor 20 may be configured to execute one or more additional components that may perform some or all of the functionality attributed below to one of components 30, 32, 34, 36, and/or 38.

In some embodiments, training component 32 is configured to obtain training images from a content source (e.g., inputs 50), electronic storage 22, external resources 24, and/or via UI device(s) 18. In some embodiments, training component 32 is connected to network 70. The connection to network 70 may be wireless or wired.

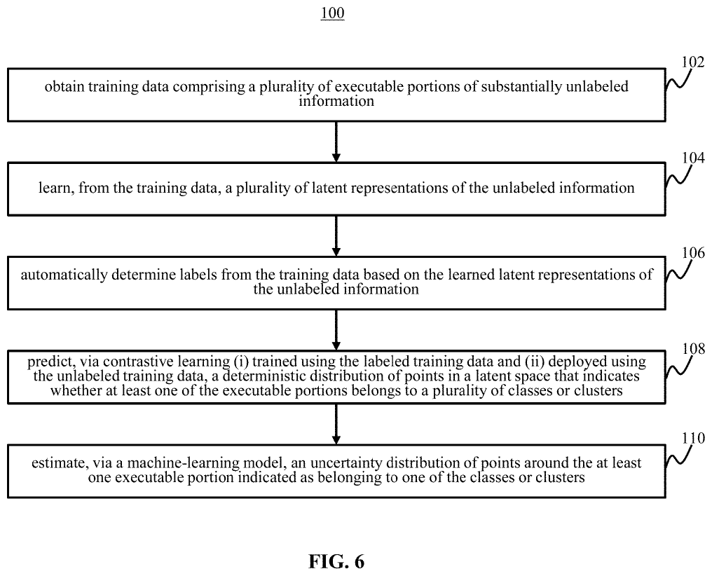

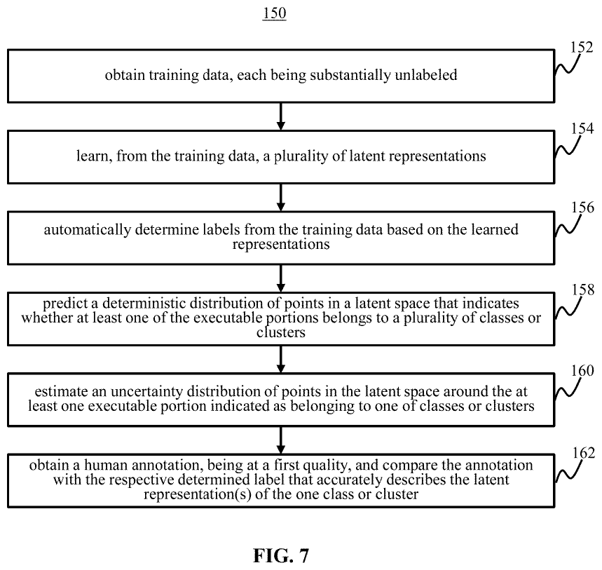

FIGS. 6-7 illustrate methods 100 and 150 for implementing self-supervised learning, e.g., via training a classifier, detector, or defender, for malware and threat intelligence, without high quality labels but with a full unlabeled dataset to achieve successful annotation performance. These methods may be performed with a computer system comprising one or more computer processors and/or other components. The processors are configured by machine readable instructions to execute computer program components. The operations of such methods are intended to be illustrative. In some embodiments, these methods may each be accomplished with one or more additional operations not described, and/or without one or more of the operations discussed. Additionally, the order in which these operations are illustrated in each of FIGS. 6-7 and described below is not intended to be limiting. In some embodiments, these methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of these operations in response to instructions stored electronically on an electronic storage medium. The processing devices may include one or more devices configured through hardware, firmware, and/or software to be specifically designed for execution of one or more of the following operations.

At operation 102 of method 100, training data comprising a plurality of executable portions of substantially unlabeled information may be obtained. As an example, training data 60-1 may comprise a pool of sample applications or another type of data. For example, the training data may be generated by users uploading different types of applications or different type of benign and malware files. Since the training data may comprise a vast amount of data samples 50, there may still be associated with them a few annotations, which system 10 may be operable to leverage as an extra layer of evaluation. In some embodiments, operation 102 is performed by a processor component the same as or similar to information component 30 (shown in FIG. 1 and described herein).

At operation 104 of method 100, a plurality of latent representations of the unlabeled information may be learned, from the training data. As an example, labeling component 34 may implement different types of fuzzing inputs (e.g., from a static binary perspective). And then there may be runtime outputs that are each based on the respective input, forming another type of augmentation that is used to have the representation. Fuzzing may thus be used to obtain different positives of an example malware or application with respect to which prediction component 36 is determining presence of malicious behavior. In some embodiments, operation 104 is performed by a processor component the same as or similar to labeling component 34 (shown in FIG. 1 and described herein).

At operation 106 of method 100, labels from the training data may be automatically determined based on the learned latent representations of the unlabeled information. As an example, labeling component 34 may learn the underlying representation of malware 50 and produce pseudo-labels therefrom. In some embodiments, app 50 may be software that critically requires a level of security, false predictions of its maliciousness (e.g., letting bad malware to be classified as benign or vice versa) being substantially unacceptable. In some embodiments, operation 106 is performed by a processor component the same as or similar to labeling component 34 (shown in FIG. 1 and described herein).

At operation 108 of method 100, a deterministic distribution of points in a latent space that indicates whether at least one of the executable portions belongs to a plurality of classes or clusters may be predicted, via contrastive learning (i) trained using the labeled training data and (ii) deployed using the unlabeled training data. In some embodiments, operation 108 is performed by a processor component the same as or similar to prediction component 36 (shown in FIG. 1 and described herein).

At operation 110 of method 100, an uncertainty distribution of points, around the at least one executable portion indicated as belonging to one of the classes or clusters, may be estimated via a machine-learning model. In some embodiments, operation 110 is performed by a processor component the same as or similar to estimation component 38 (shown in FIG. 1 and described herein).

At operation 152 of method 150, training data may be obtained, each datum being substantially unlabeled. In some embodiments, operation 152 is performed by a processor component the same as or similar to training component 32 (shown in FIG. 1 and described herein).

At operation 154 of method 150, a plurality of latent representations may be learned, from the training data. In some embodiments, operation 154 is performed by a processor component the same as or similar to labeling component 34 (shown in FIG. 1 and described herein).

At operation 156 of method 150, labels may be automatically determined from the training data based on the learned representations. In some embodiments, operation 156 is performed by a processor component the same as or similar to labeling component 34 (shown in FIG. 1 and described herein).

At operation 158 of method 150, a deterministic distribution of points in a latent space that indicates whether at least one of the executable portions belongs to a plurality of classes or clusters may be predicted. In some embodiments, operation 158 is performed by a processor component the same as or similar to prediction component 36 (shown in FIG. 1 and described herein).

At operation 160 of method 150, an uncertainty distribution of points in the latent space around the at least one executable portion indicated as belonging to one of classes or clusters may be estimated. In some embodiments, operation 160 is performed by a processor component the same as or similar to estimation component 38 (shown in FIG. 1 and described herein).

At operation 162 of method 150, a human annotation, being at a first quality, may be obtained; and the annotation may be compared with the respective determined label that accurately describes the latent representation(s) of the one class or cluster. In some embodiments, operation 162 is performed by a processor component the same as or similar to information component 30 (shown in FIG. 1 and described herein).

Techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

Several embodiments of the disclosure are specifically illustrated and/or described herein. However, it will be appreciated that modifications and variations are contemplated and within the purview of the appended claims.

What is claimed is:

1. A computer-implemented method of uncertainty aware self-supervision, the method comprising:
obtaining training data comprising a plurality of executable portions of substantially unlabeled information;
learning, from the training data, a plurality of latent representations of the unlabeled information;
automatically determining labels from the training data based on the learned plurality of latent representations;
predicting, via contrastive learning (i) trained using the labeled training data and (ii) deployed using the training data, a deterministic distribution of points in a latent space that indicates whether at least one of the executable portions belongs to a plurality of classes or clusters; and
estimating, via a machine-learning model, an uncertainty distribution of points around the at least one executable portion indicated as belonging to one of the classes or clusters,
wherein the uncertainty distribution indicates a confidence that the respective automatically determined label accurately describes the latent representation(s) of the one class or cluster.

2. The method of claim 1, further comprising:
performing fuzzing to generate a plurality of different malware samples based on the executable portion.

3. The method of claim 2, further comprising:
performing, via simulating an environment, dynamic analysis such that each of the plural malware samples dynamically outputs a different input response.

4. The method of claim 3, wherein the automatic determinations of the labels are performed by optimizing a loss on pairwise samples such that the different samples executing in the simulated environment are represented closely in the latent space.

5. The method of claim 1, further comprising:
transforming the executable portion from a binary form into pixel values.

6. The method of claim 1, wherein the executable portions comprise malware and benign software, the malware and the benign software having maximum dissimilarity.

7. The method of claim 1, further comprising:
estimating epistemic and aleatoric uncertainty of a self-supervised learner performing the uncertainty aware self-supervision.

8. The method of claim 1, wherein the estimated uncertainty distribution is estimated via at least one of a Monte Carlo dropout, Bayes by backpropagation, a bootstrap, and ensemble learning.

9. The method of claim 1, wherein the labels comprise descriptive annotations.

10. The method of claim 1, wherein a system performing the method comprises a set of encoders, each comprising a different ResNet backbone.

11. The method of claim 10, wherein the system further comprises a contrastive learner, comprising a projection head that performs a transformation on the latent representations, the latent representations being embeddings.

12. The method of claim 1, further comprising:
estimating another uncertainty distribution; and
responsive to determining another confidence, which does not satisfy a quality criterion, of the other uncertainty distribution of points for one of the learned plurality of latent representations, feeding the one learned representation back into a learning loop.

13. The method of claim 1, wherein the uncertainty distribution is for at least one of a plurality of dimensions in the latent space.

14. A method of artificial intelligence (AI), the method comprising:
obtaining training data, each being substantially unlabeled;
learning, from the training data, a plurality of latent representations;
automatically determining labels from the training data based on the learned plurality of latent representations;
predicting a deterministic distribution of points in a latent space that indicates whether at least one executable portion belongs to a plurality of classes or clusters;
estimating an uncertainty distribution of points in the latent space around the at least one executable portion indicated as belonging to one of classes or clusters; and
obtaining a human annotation, being at a first quality, and comparing the annotation with the respective automatically determined label that accurately describes the latent representation(s) of the one class or cluster.

15. The method of claim 14, further comprising:
performing fuzzing to generate a plurality of different malware samples based on the executable portion.

16. The method of claim 15, further comprising:
performing, via simulating an environment, dynamic analysis such that each of the malware samples dynamically outputs a different input response.

17. The method of claim 16, wherein the automatic determinations of the labels are performed by optimizing a loss on pairwise samples such that the different samples executing in the simulated environment are represented closely in the latent space.

18. The method of claim 14, further comprising:
transforming the executable portion from a binary form into pixel values.

19. The method of claim 14, further comprising:
estimating another uncertainty distribution; and
responsive to determining another confidence, which does not satisfy a quality criterion, of the other uncertainty distribution of points for one of the learned representations, feeding the one learned representation back into a learning loop.

20. A non-transitory computer-readable medium comprising instructions executable by at least one processor to perform a method, the method comprising:
obtaining training data comprising a plurality of executable portions of substantially unlabeled information;
learning, from the training data, a plurality of latent representations of the unlabeled information;
automatically determining labels from the training data based on the learned plurality of latent representations of the unlabeled information;
predicting, via contrastive learning (i) trained using the labeled training data and (ii) deployed using the training data, a deterministic distribution of points in a latent space that indicates whether at least one of the executable portions belongs to a plurality of classes or clusters; and
estimating, via a machine-learning model, an uncertainty distribution of points that indicates a confidence that the respective automatically determined label accurately describes the latent representation(s) of one of the classes or clusters.
